(19) United States
(12) Patent Application Publication
(10) Pub. No.: US 2023/0219490 A1
(43) Pub. Date: Jul. 13, 2023

(54) SWITCH DEVICE

(71) Applicant: KABUSHIKI KAISHA TOKAI RIKA DENKI SEISAKUSHO, Aichi (JP)

(72) Inventor: Yasutaka MATSUDA, Aichi (JP)

(73) Assignee: KABUSHIKI KAISHA TOKAI RIKA DENKI SEISAKUSHO, Aichi (JP)

(21) Appl. No.: 18/009,536

(22) PCT Filed: Feb. 17, 2021
(86) PCT No.: PCT/JP2021/005856

§ 371 Date: Dec. 9, 2022

(30) Foreign Application Priority Data
Jun. 18, 2020 (JP) 2020-105158

(51) Int. Cl. B60Q 1/14; B60S 1/08

(52) U.S. Cl. CPC B60Q 1/1476; B60S 1/0811

(57) ABSTRACT

The switch device is mounted on a vehicle capable of travelling in an automatic driving mode, and is configured to operate at least one function of a wiper function and a light function. The switch device includes an operation lever which is configured to select one operation mode from a plurality of operation modes included in the at least one function and configured to return to a neutral position when the selected operation mode is released, and a feedback unit which is configured to feed back to an operator of the operation lever information indicating that one operation mode has been selected from the plurality of operation modes by using the operation lever.

### TECHNICAL FIELD

The present disclosure relates to a switch device.

### BACKGROUND ART

Conventionally, there is known a lever-type switch device mounted on a vehicle. For example, Japanese Patent Laying-Open No. 2010-202035 discloses a wiper switch device which is provided with a momentary switch operation lever. This switch device includes a click mechanism that transmits a click feeling to an operator for each operation position (operation mode) of the switch operation lever.

### CITATION LIST

### Patent Literature

PTL 1: Japanese Patent Application Laying-Open No. 2010-202035

### SUMMARY OF INVENTION

### Technical Problem

In a vehicle capable of travelling in an automatic driving mode, for example, an occupant may operate a wiper function or a light function. At this time, it is desirable to appropriately feed back to the operator which operation mode among a plurality of operation modes in the wiper function or the light function has been selected by the operator.

It is an object of the present disclosure to provide a switch device which is mounted on a vehicle capable of travelling in an automatic driving mode and is configured to feed back to an operator an operation mode selected by the operator.

### Solution to Problem

A switch device according to the present disclosure is mounted on a vehicle capable of travelling in an automatic driving mode, and is configured to operate at least one of a wiper function and a light function. The switch device includes an operation lever which is configured to select one operation mode from a plurality of operation modes included in the at least one function and configured to return to a neutral position when the selected operation mode is released, and a feedback unit which is configured to feed back to an operator of the operation lever information indicating that the one operation mode has been selected from the plurality of operation modes by using the operation lever.

### Advantageous Effects of Invention

According to the present disclosure, it is possible to provide a switch device which is mounted on a vehicle capable of travelling in an automatic driving mode and is configured to feed back to an operator an operation mode selected by the operator.

### BRIEF DESCRIPTION OF DRAWINGS

FIG. 1 is a view schematically illustrating a switch device according to an embodiment of the present disclosure;

FIG. 2 is a view schematically illustrating a relationship between an operation mode of a wiper function and an operation position of an operation lever; and

FIG. 3 is a table illustrating a relationship between an operation stroke and the number of times of information generation.

### DESCRIPTION OF EMBODIMENTS

An embodiment of the present disclosure will be described with reference to the drawings. In the following drawings, the same or equivalent members are denoted by the same reference numerals.

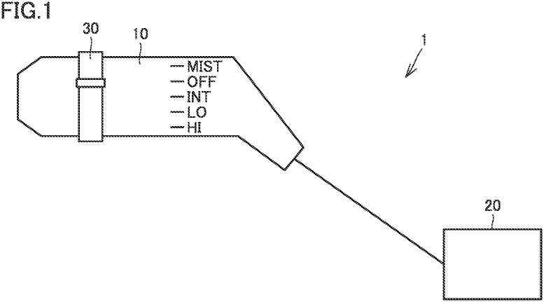

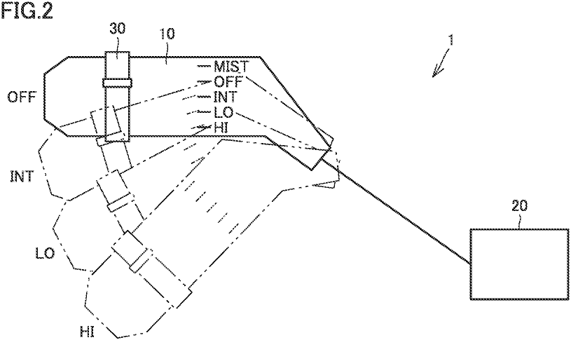

FIG. 1 is a view schematically illustrating a switch device according to an embodiment of the present disclosure. FIG. 2 is a view schematically illustrating a relationship between an operation mode of a wiper function and an operation position of an operation lever.

The switch device 1 is mounted on a vehicle capable of travelling in an automatic driving mode. The switch device 1 is configured to operate at least one function of a wiper function and a light function. Hereinafter, a case where the switch device 1 is used to operate a wiper function will be described as an example.

The wiper function includes a plurality of operation modes. As illustrated in FIG. 2, the plurality of operation modes include a stop mode (OFF) in which the wiper is stopped, an interval mode (INT) in which the wiper is intermittently driven, a low speed mode (LO) in which the wiper is driven at a low speed, and a high speed mode (HI) in which the wiper is driven at a high speed.

The switch device 1 of the present embodiment includes an operation lever 10, a feedback unit 20, and an operation unit 30.

The operation lever 10 is configured to select one operation mode from a plurality of operation modes included in the wiper function. The operation lever 10 is formed as a so-called momentary operation lever. In other words, the operation lever 10 is configured to return to the neutral position when a selected operation mode is released. In the present embodiment, the stop mode is set to the neutral position.

As illustrated in FIG. 2, an operation stroke of the operation lever 10 from the neutral position (the stop mode) is set to increase in the order of the interval mode, the low speed mode, and the high speed mode. In FIG. 2, the operation lever 10 at each operation position of the interval mode (INT), the low speed mode (LO), and the high speed mode (HI) is indicated by a two-dot chain line.

When one operation mode is selected from the plurality of operation modes by using the operation lever 10, the feedback unit 20 feeds back to the operator of the operation lever 10 information indicating that the operation mode has been selected. In the present embodiment, the feedback unit 20 feeds back the information by vibration. An eccentric motor, a piezo element, or the like may be used to generate the vibration.

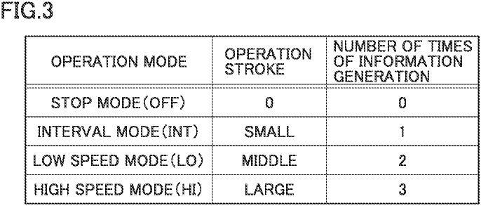

The feedback unit 20 feeds back different information to the operation lever 10 in response to the operation mode. In the present embodiment, as illustrated in FIG. 3, the feedback unit 20 increases the number of times of information generation as the operation stroke of the operation lever 10 from the neutral position increases. In other words, in the present embodiment, the number of times of vibration generation increases in the order of the interval mode, the low speed mode, and the high speed mode. The number of the generated vibrations illustrated in FIG. 3 may be modified appropriately.

Further, the feedback unit 20 may increase the number of times of information generation as the speed of the wiper increases. In the present embodiment, even when the operation position of each operation mode is different from that illustrated in FIG. 2, the number of times of vibration generation may increase in the order of the interval mode, the low speed mode, and the high speed mode.

The operation unit 30 is provided on the operation lever 10 so as to be movable relative to the operation lever 10. In the present embodiment, the operation unit 30 is provided on the operation lever 10 so as to be rotatable relative to the operation lever 10. The operation unit 30 is configured to adjust an actuation interval of the wiper in the interval mode. The operation unit 30 is also formed as a momentary operation unit. For example, the actuation interval of the wiper is set to be shorter as the operation stroke from the neutral position of the operation unit 30 becomes larger.

It is preferable that the feedback unit 20 feeds back different information to the operation lever 10 in response to the actuation interval of the wiper in the interval mode. For example, the feedback unit 20 increases the number of times of information generation as the operation stroke from the neutral position of the operation unit 30 increases.

As described above, the switch device 1 of the present embodiment mounted in a vehicle capable of traveling in an automatic driving mode appropriately feeds back to the operator which operation mode among the plurality of operation modes included in the wiper function is selected by the operator.

It should be noted that the embodiments disclosed herein are illustrative and not restrictive in all respects. The scope of the present disclosure is not limited to the description above but defined by the scope of the claims and encompasses all modifications equivalent in meaning and scope to the claims.

For example, the switch device 1 may be used to operate the light function. The light function includes a plurality of operation modes. The plurality of operation modes include an OFF mode in which a light is turned off, a front position light mode in which a front position light is turned on, a low beam mode in which a low beam is turned on, and a high beam mode in which a high beam is turned on. When the switch device 1 is used to operate the light function, the feedback unit 20 increases the number of times of vibration generation in the order of the front position light mode, the low beam mode, and the high beam mode.

Further, the feedback unit 20 may feed back sound instead of vibration as the information. Alternatively, the feedback unit 20 may feedback the selected operation mode by voice.

The feedback unit 20 may also feed back a mechanical click feeling.

The exemplary embodiments described above are illustrative examples of the following aspects.

A switch device according to an aspect of the present invention is a s switch device which is mounted on a vehicle capable of travelling in an automatic driving mode, and is configured to operate at least one function of a wiper function and a light function. The switch device includes an operation lever which is configured to select one operation mode from a plurality of operation modes included in the at least one function and configured to return to a neutral position when the selected operation mode is released, and a feedback unit which is configured to feed back to an operator of the operation lever information indicating that the one operation mode has been selected from the plurality of operation modes by using the operation lever.

According to this aspect, the switch device mounted in the vehicle capable of traveling in the automatic driving mode appropriately feeds back to the operator which operation mode among the plurality of operation modes included in the wiper function or the light function is selected by the operator.

It is preferable that the at least one function includes the wiper function, and the plurality of operation modes include a stop mode in which a wiper is stopped, an interval mode in which the wiper is intermittently driven, a low speed mode in which the wiper is driven at a low speed, and a high speed mode in which the wiper is driven at a high speed.

It is preferable that the feedback unit feeds back different information to the operation lever in response to the selected operation mode.

Thus, it is possible for the operator to easily determine which operation mode has been selected by using the operation lever.

For example, the feedback unit may increase the number of times of information generation as the operation stroke from the neutral position of the operation lever increases.

Alternatively, the feedback unit may increase the number of times of information generation as the speed of the wiper increases.

It is preferable that the switch device further includes an operation unit which is provided on the operation lever so as to be movable relative to the operation lever and is configured to adjust an actuation interval of the wiper in the interval mode, and the feedback unit feeds back different information to the operation lever in response to the actuation interval.

### REFERENCE SIGNS LIST

1: switch device; 10: operation lever; 20: feedback unit; 30: operation unit

1. A switch device which is mounted on a vehicle capable of travelling in an automatic driving mode, and is configured to operate at least one function of a wiper function and a light function, the switch device comprising:
an operation lever which is configured to select one operation mode from a plurality of operation modes included in the at least one function and configured to return to a neutral position when the selected operation mode is released; and
a feedback unit which is configured to feed back to an operator of the operation lever information indicating that the one operation mode has been selected from the plurality of operation modes by using the operation lever.

2. The switch device according to claim 1, wherein
the at least one function includes the wiper function,
the plurality of operation modes include a stop mode in which a wiper is stopped, an interval mode in which the wiper is intermittently driven, a low speed mode in which the wiper is driven at a low speed, and a high speed mode in which the wiper is driven at a high speed.

3. The switch device according to claim 2, wherein
the feedback unit feeds back different information to the operation lever in response to the selected operation mode.

4. The switch device according to claim 3, wherein
the feedback unit increases the number of times of information generation as an operation stroke from the neutral position of the operation lever increases.

5. The switch device according to claim 3, wherein
the feedback unit increases the number of times of information generation as a speed of the wiper increases.

6. The switch device according to claim 2, further comprising:
an operation unit which is provided on the operation lever so as to be movable relative to the operation lever, and is configured to adjust an actuation interval of the wiper in the interval mode,
wherein the feedback unit feeds back different information to the operation lever in response to the actuation interval.
